(19) United States
(12) Patent Application Publication
(10) Pub. No.: US 2019/0366580 A1
(43) Pub. Date: Dec. 5, 2019

(54) CHAIN SAW

(71) Applicant: Nanjing Chervon Industry Co., Ltd., Nanjing (CN)

(72) Inventor: Yang Lu, Nanjing (CN)

(21) Appl. No.: 16/407,790

(22) Filed: May 9, 2019

(30) Foreign Application Priority Data
Jun. 5, 2018 (CN) 201810566351.7

(51) Int. Cl. B27B 17/14; B27B 17/02; B27B 17/10

(52) U.S. Cl. CPC B27B 17/14; B27B 17/10; B27B 17/02

(57) ABSTRACT

A chain saw includes a chain, a guide plate for supporting and guiding the chain, a main body comprising a power output unit configured for driving the chain to cut a workpiece, and a locking device configured for fixing the guide plate and tensioning the chain. The locking device includes a device housing, an operating member configured to be operated by a user to rotate about a first axis, a first locking member configured for locking or releasing the guide plate, and a first clutch assembly comprising a first clutch and a second clutch. The first clutch assembly has a first state and a second state, the first clutch is operative to transmit a rotation of the operating member to the second clutch when the first clutch assembly is in the first state, the first clutch is operative to stop transmitting the rotation to the second clutch and the first clutch assembly is operative to produce a relative displacement relative to the second clutch when the first clutch assembly is in the second state.

### RELATED APPLICATION INFORMATION

This application claims the benefit under 35 U.S.C. § 119(a) of Chinese Patent Application No. CN 201810566351.7, filed on Jun. 5, 2018, which application is incorporated herein by reference in its entirety herein.

### TECHNICAL FIELD

The present disclosure relates generally to power tools and, more particularly, to a chain saw.

### BACKGROUND

As a power tool, a chain saw includes a chain with a plurality of cutting portions for performing a cutting function. After a long period of work, the chain may become slack, which may affect the cutting performance. The existing chain tensioning devices are complicated in structure and are inconvenient to operate.

### SUMMARY

A chain saw is described which includes a chain, a guide plate for supporting and guiding the chain, a main body comprising a power output unit configured for driving the chain to cut a workpiece, and a locking device configured for fixing the guide plate and tensioning the chain. An example locking device comprises a device housing, an operating member configured to be operated by a user to rotate about a first axis, a first locking member configured for locking or releasing the guide plate, and a first clutch assembly comprising a first clutch and a second clutch. The first clutch assembly has a first state and a second state, the first clutch is operative to transmit a rotation of the operating member to the second clutch when the first clutch assembly is in the first state, the first clutch is operative to stop transmitting the rotation to the second clutch and the first clutch assembly is operative to produce a relative displacement relative to the second clutch when the first clutch assembly is in the second state.

In some examples, the relative displacement of the first clutch relative to the second clutch has a displacement component along the first axis.

In some examples, the relative displacement of the first clutch relative to the second clutch has a displacement component along the radial direction perpendicular to the first axis.

In some examples, the first clutch includes a first elastic member and a pin, which are fixedly or detachably connected.

In some examples, the second clutch is formed with a clutching portion, and the first clutch is biased to a position that is always in constant contact with the clutching portion.

In some examples, the clutching portion includes a first sloped surface and a second sloped surface. The first sloped surface defines a first slope, and the second sloped surface defines a second slope.

In some examples, the locking device further includes a second locking member. The first locking member is fixedly connected or integrally formed with the operating member, the second locking member is connected to the main body and passes through the guide plate, and the first clutch is fixedly or detachably connected to the operation member.

In some examples, the second locking member is moveable relative the first locking member to clamp the guide plate.

In some examples, the locking device further includes a pawl, which is detachably connected to the device housing; so that the second clutch is operative to rotate in only one direction. The second clutch is formed with a ratchet, and the pawl is unidirectionally engaged with the ratchet so that the second clutch is operative to rotate in only one direction.

In some examples, the chain saw further includes a push plate that is fixedly connected to the guide plate and formed with a convex portion and a driving member formed with a spiral block which is operative to move simultaneously with the second clutch to push the convex portion to tension the chain.

The chain saw according to in the present disclosure realizes the tensioning of the chain during the process of installing the locking device, thereby reducing the operational steps of the chain tensioning. The locking of the guide plate can also be achieved every time the chain is tensioned, and the clutch device can be prevented from tensioning or over-tensioning, and does not need to be manually interpreted to apply with tension. After the chain is relaxed, it is convenient and quick to tighten again.

### BRIEF DESCRIPTION OF DRAWINGS

FIG. 1 is a perspective schematic view illustrating a chain saw in a first example;

FIG. 2 is a schematic view illustrating the chain saw of FIG. 1 with a locking device removed;

FIG. 3 is an exploded schematic view of the locking device of the chain saw of FIG. 1;

FIG. 4 is an exploded view of the locking device of the chain saw of FIG. 3 viewed from another perspective;

FIG. 5 is a cross-sectional view of the locking device of the chain saw of FIG. 1;

FIG. 6 is a schematic view illustrating a second clutch and a driving member of FIG. 4;

FIG. 7 is a schematic view of the second clutch and the driving member of FIG. 6 viewed from another perspective;

FIG. 8 is a schematic view of the second clutch and the driving member of FIG. 7 after they are combined;

FIG. 9 is an exploded view illustrating a locking device of a chain saw of a second example in accordance with the present disclosure;

FIG. 10 is an exploded view of the locking device of the chain saw of FIG. 9 viewed from another perspective;

FIG. 11 is a schematic view of the third clutch and the fourth clutch where they are located in the operating member in a third state in the second example;

FIG. 12 is a partial enlarged view of part A of FIG. 11; and

FIG. 13 is a schematic view of the third clutch and the fourth clutch where they are located in the operating member in a fourth state in the second example.

### DETAILED DESCRIPTION

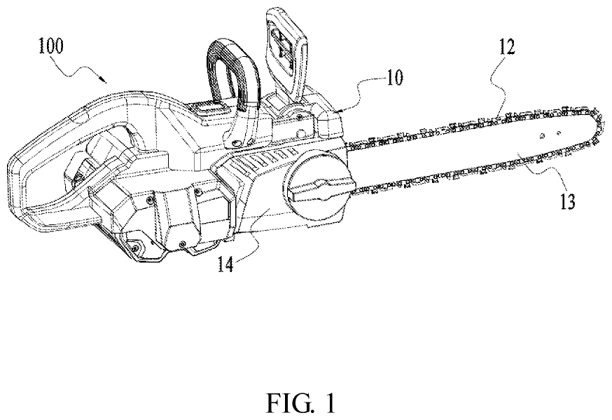

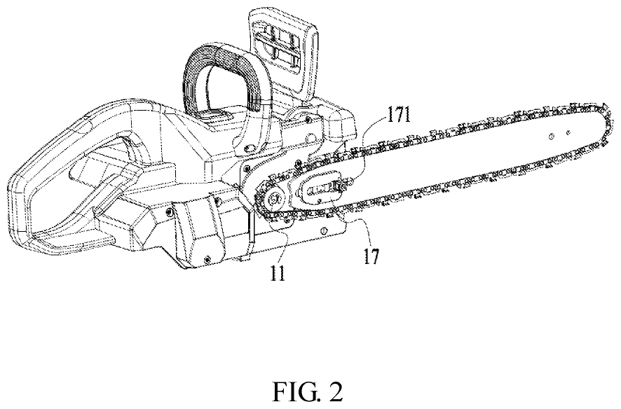

The chain saw 100 of the first example shown in FIG. 1 includes a main body 10, a chain 12, a guide plate 13, and a locking device 14. As shown in FIG. 2, the main body 10 includes a power output unit 11 configured for outputting power to the drive chain 12. The guide plate 13 is used for guiding the chain 12 to rotate around the guide plate 13.

The locking device 14 is configured for fixing the guide plate 13 and tensioning the chain 12. The locking device 14 is detachably connected to the main body 10. The guide plate 13 is disposed between the main body 10 and the locking device 14. The locking device 14 and the main body 10 clamp the guide plate 13. As shown in FIG. 1 and FIG. 2, the locking device 14 is installed to the joint of the guide plate 13 and the main body 10.

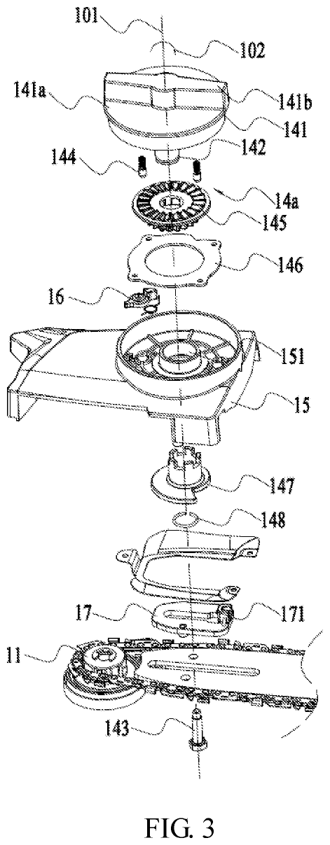

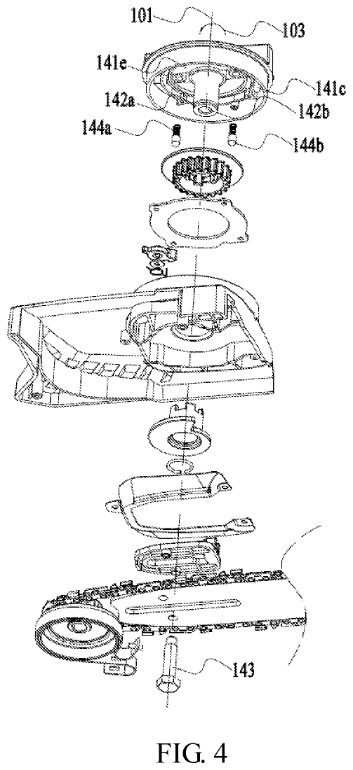

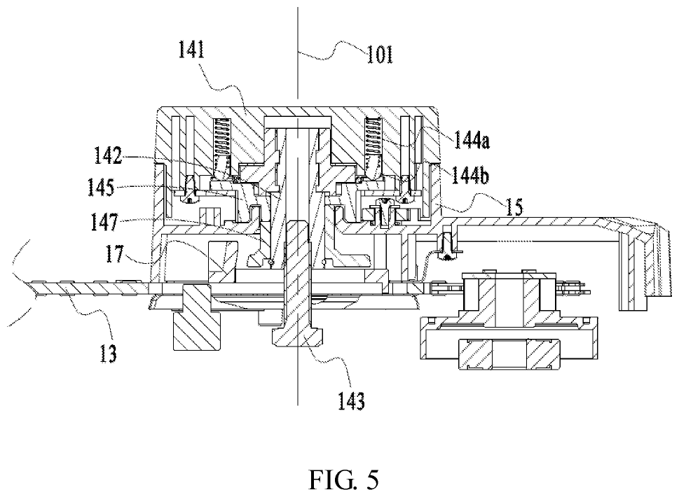

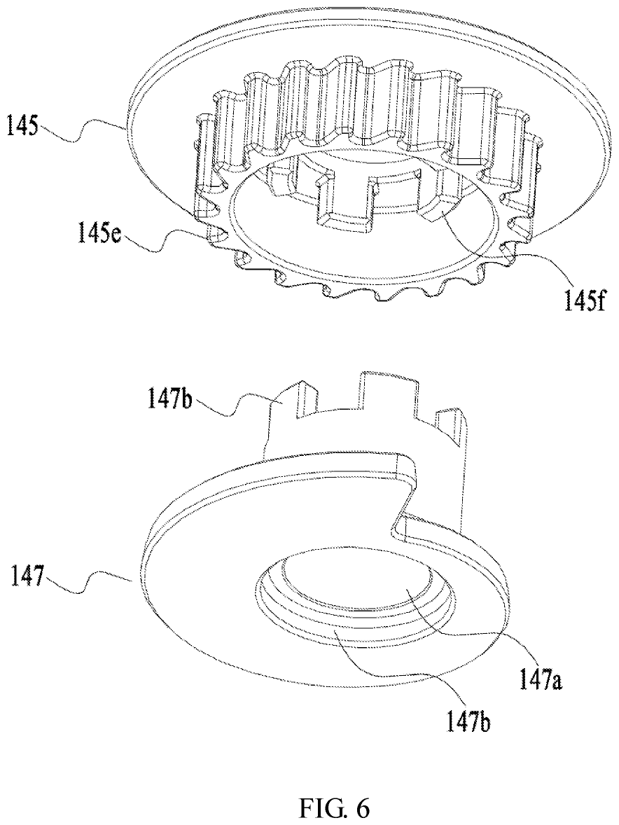

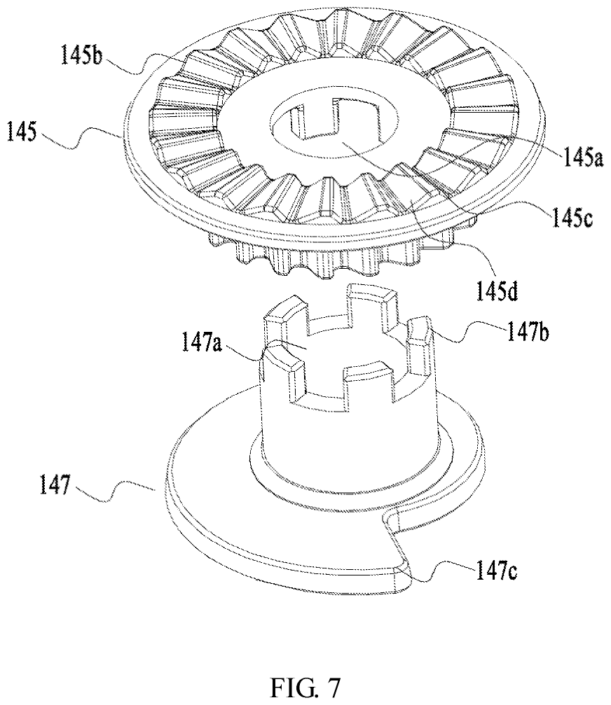

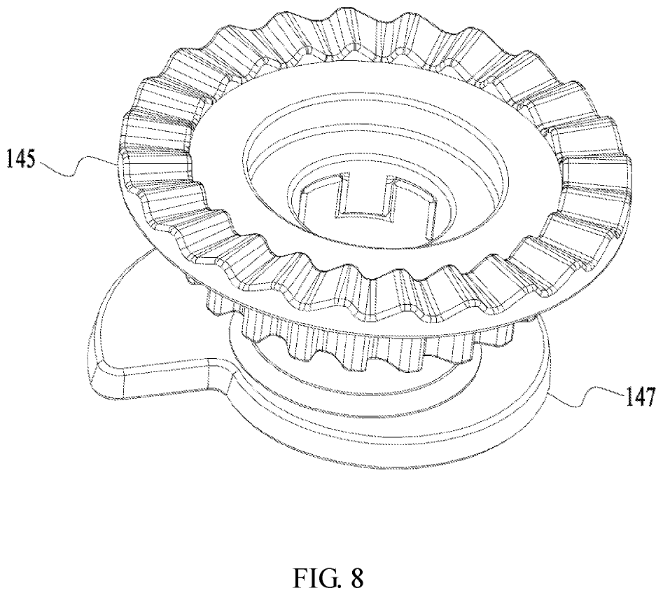

As shown in FIG. 2 to FIG. 8, the locking device 14 includes: an operating member 141, a first locking member 142, a second locking member 143, a first clutch assembly 14a, a first mounting member 146, a driving member 147, and a device housing 15.

The operating member 141 is rotatable about a first axis 101 relative the main body 10. The first locking member 142 is fixedly connected to the operating member 141, or the first locking member 142 is integrally formed with the operating member 141. The first locking member 142 is a cylindrical nut extending along the first axis 101, and the first locking member 142 is formed with an internal thread hole 142b. The first locking member 142 includes a first end and a second end, the first end is fixedly connected to the operating member 141, and the second end is formed with a limit slot 142a.

The second locking member 143 is a bolt with external threads. The second locking member 143 can insert to the internal thread hole 142b of the first locking member 142.

The first clutch assembly 14a includes a first clutch 144 and a second clutch 145, and the first clutch 144 is detachably connected to the operating member 141. The second clutch 145 is sleeved onto the first locking member 142 and assembled to the operating member 141 through the first mounting member 146. The first clutch 144 produces relative displacement relative to the second clutch 145, the relative displacement enables the first clutch 144 to change position along a first line 104 with respect to the second clutch 145. The relative displacement of the first clutch 144 relative to the second clutch may be a translation of the first clutch 144 relative to the second clutch 145, or a rotation of the first clutch 144 relative to the second clutch 145, or a combined motion of translation and rotation of the first clutch 144 relative to the second clutch 145. That is to say, the relative displacement of the first clutch 144 relative to the second clutch 145 has a displacement component in the direction of the first axis 101. Or in other examples, the relative displacement of the first clutch 144 relative to the second clutch 145 has a displacement component in the direction perpendicular to the first axis 101. In fact, it is within the scope of the present disclosure to vary the position of the first clutch 144 relative to the second clutch 145 in space. In the present example, the first line 104 is parallel to the first axis 101.

The driving member 147 is sleeved onto the first locking member 142 and is detachably connected to the second clutch 145. The driving member 147 can rotate synchronously with the second clutch 145 about the first axis 101.

The device housing 15 is used to connect with the main body 10. The operating member 141 is mounted on the device housing 15.

The chain saw 100 includes a push plate 17. The driving member 147 can drive the push plate 17 to move when rotating, and then the push plate 17 pushes the guide plate 13 to move away from the power output unit 11, thereby tensioning the chain 12.

The operating member 141 includes a first surface 141a and a second surface 141c, the first surface 141a is formed with an operating portion 141b for a user to operate, and the second surface 141c is formed with a first receiving space configured for receiving the second clutch 145. A screw hole 141d for fixing the first mounting member 146 is distributed in the first receiving space in a direction of centering around the first axis 101. Further, a first receiving cavity 141e for receiving the first clutch 144 is formed in the first receiving space.

The first clutch 144 includes a first elastic member 144a and a pin 144b. The first elastic member 144a is a spring. The pin 144b consists of a cylinder and a spherical body. The first elastic member 144a and the pin 144b constitute a fixed connection or a detachable connection and are installed in the first receiving cavity 141e of the operating member 141.

The second clutch 145 is formed with a first through hole 145a penetrating through itself in the direction of the first axis 101, and the first locking member 142 passes through the first through hole 145a. The second clutch 145 further includes a third surface and a fourth surface. The third surface is formed with a clutching portion 145b that cooperates with the first clutch 144, the clutching portion 145b is formed by protrusions surrounding the first through hole 145a, and the protrusions include a first sloped surface 145c and a second sloped surface 145d. The first sloped surface 145c has a first slope, and the second sloped surface 145d has a second slope, and the absolute value of the first slope is greater than that of the second slope. It can be understood that when the user operates the operating member 141 to rotate in a first direction 102 around the first axis 101, the first clutch 144 pushes first sloped surface 145c. At this time, since the absolute value of first slope of the first sloped surface 145c is large, the first clutch 144 is difficult to passes over the protrusions along the first sloped surface 145c. And when the user operates the operating member 141 to rotate in a second direction 103 around the first axis 101, the first clutch 144 pushes the second sloped surface 145d. At this time, since the absolute value of second slope of the second sloped surface 145d is small, the first clutch 144 is easy to passes over the protrusions along the second sloped surface 145d. The fourth surface extends around the first through hole 145a to form a ratchet 145e. The locking device 14 includes a pawl 16, the pawl 16 prevents reverse rotation of the second clutch 145 when cooperates with the ratchet 145e. Further, the second clutch 145 surrounds the first through hole 145a to form first transmission teeth 145f, and the first transmission teeth 145f is used to drive the driving member to rotate with the second clutch 145. The first transmission teeth 145f are evenly arranged around the first through hole 145a, and the first transmission teeth 145f are located in the inside the circumference surround by the ratchet 145e. In this example, the first direction 102 is a direction in which the operating member 141 rotates clockwise relative to the main body 10, and the second direction 103 is a direction in which the operating member 141 rotates counterclockwise relative to the main body 10. Of course, those skilled in the art can also make out the opposite understanding of the first direction 102 and the second direction 103 described above.

The driving member 147 is formed with a second through hole 147a around the first axis 101 for receiving the first locking member 142. The driving member 147 further includes a third end and a fourth end. The third end is formed with second transmission teeth 147b that fit the first transmission teeth 145f around the second through hole 147a. The second clutch 145 and the driving member 147 are connected by the first transmission teeth 145f and the second transmission teeth 147b to form a synchronous rotation. Further, the fourth end of the driving member 147 is further formed with a spiral block 147c extending around the second through hole 147a. It can be understood that the radius of the spiral block 147c gradually increases around the second through hole 147a and finally reaches a preset value. As the radius gradually increases, the size of the spiral block 147c protruding from the second through hole 147a gradually increases. During the rotation of the driving member 147, the spiral block 147c pushes a convex portion 171 of the push plate 17 to gradually tension the chain 12. And the fourth end of the second through hole 147a is formed with a stop groove 147d. The locking device 14 includes a locking ring 148. The locking ring 148 is partially located in the stop groove 147d and partially embedded in the limit slot 142a of the first locking member 142, thereby limiting the driving member 147 disengaged from the second clutch 145.

The device housing 15 is formed with a fifth surface and a sixth surface. The fifth surface is formed with a third through hole 151 penetrating through itself in the direction of the first axis 101 and configured for the first locking member 142 and the driving member 147 to pass through. At the same time, a second receiving space is formed around the third through hole 151, and cooperates with the first receiving space of the operating member 141 to form a second receiving cavity. The first locking member 142, the first clutch 144, the second clutch 145 and the first mounting member 146 are at least partially located in the second receiving cavity, and the pawl 16 is connected to the second receiving space by screws. A second elastic member is disposed between the pawl 16 and the device housing 15, and the second elastic member generates an elastic force for driving the pawl 16 to always cooperate with the ratchet 145e. An engaging portion of the pawl 16 is unidirectionally engaged with a slot of the ratchet 145e, so that the ratchet 145e can only be rotated in one direction at a time. In this example, the number of the pawl 16 is two. The sixth surface is formed with a receiving space that at least partially receives the power output unit 11, the guide plate 13, and the chain 12.

In this example, when the first clutch 144 is mounted to the first receiving cavity, and then the second clutch 145 is sleeved onto the first locking member 142 until the first clutch 144 contacts the clutching portion 145b of the second clutch 145 to generate a preload. Here, the elastic force of the first clutch 144 has been adjusted to a optimal elastic force according to the preset tension of the tension chain 12. At this moment, the first mounting member 146 is sleeved onto the ratchet 145e of the second clutch 145 and connected to the operating member 141 by screws, thereby ensuring that the second clutch 145 does not disengage from the operating member 141 and the preload is produced between the first clutch 144 and the second clutch 145.At this moment, the ratchet 145e of the second clutch 145 is engaged with the pawl 16 so that only one-way rotation can be performed. In this example, the second clutch 145 is preset to be rotatable only in the first direction 102. Further, the operating member 141 is mounted to the fifth surface of the device housing 15 to form a second receiving cavity. The driving member 147 is inserted from the third through hole 151 of the sixth surface, and the first transmission teeth 145f and the second fitting teeth 147b are engaged with each other, so that the second clutch 145 and the driving member 147 form a synchronous rotation. At this moment, the first locking member 142 passes through the first through hole 145a of the second clutch 145 and the second through hole 147a of the driving member 147, and the locking ring 148 is locked into the limit slot 142a of the first locking member 142, thereby limiting the driving member 147 from the second clutch 145, the above-mentioned components form a complete locking device 14 by the above-mentioned connection. The push plate 17 is fixedly connected to the guide plate 13, and the second locking member 143 is inserted into the limit slot 142a where the guide plate 13 and the push plate 17 are overlapped. The second locking member 143 is fixed to the main body 10. Specifically, the second locking member 143 is a bolt with external threads.

When the locking device 14 is mounted onto the main body 10, the screw hole 141d of the first locking member 142 is engaged with the second locking member 143, so that the first locking member 142 and the second locking member 143 are at least partially located in the screw hole 141d of the first locking member 142. It can be understood that when the user twist the operating member 141 to rotate in the first direction 102, the first clutch 144 pushes the first sloped surface 145c and drives the second clutch 145 and the driving member 147 to rotate in the first direction 102, and the first clutch 144 and the second clutch 145 are in a first state. At this moment, the radius of the spiral block 147c is gradually increased, the push plate 17 drives the guide plate 13 to gradually move away from the power output unit 11. Since the chain 12 is fixed to the power output unit 11 at one end and gradually separated from the power output unit 11 at the other end, it is gradually tensioned until the preset tension is reached. At this moment, the first elastic member 144a of the first clutch 144 reaches the maximum elastic force. In the above process, the first clutch 144 and the second clutch 145 are in a first state, and the first clutch 144 cannot pass over the first slope 145c. Continuing to rotate the operating member 141, the pin 144b of the first clutch 144 passes over the first slope 145c, the first clutch 144 and the clutching portion 145b are in relative motion, and the first clutch 144 and the second clutch 145 are in a second state. The second clutch 145 does not rotate synchronously with the operating member 141 along the first direction 102. Further, since the guide plate 13 is clamped between the first locking member 142 and the second locking member 143, therefore, continuing to rotate the operating member 141 causes the second locking member 143 to gradually move upward when the first clutch 144 and the second clutch 145 are in the second state, and then the first locking member 142 is gradually tightened to the second locking member 143 and the guide plate 13 is gradually clamped to the main body 10.When the guide plate 13 needs to be disassembled, the user twists the operating member 141 in the second direction 103. Since the second clutch 145 can only rotate in the first direction 102, at this moment, the first clutch 144 cannot drive the second clutch 145 to rotate synchronously. The first clutch 144 and the second clutch 145 are in the second state, and the first clutch 144 pushes the second sloped surface 145d, since the absolute value of the second slope is small the user can twist the operating member 141 with a small torque. The first locking member 142 and the second locking member 143 are quickly loosened, so that the guide plate 13 can be detached from the main body 10 and thus disassembled.

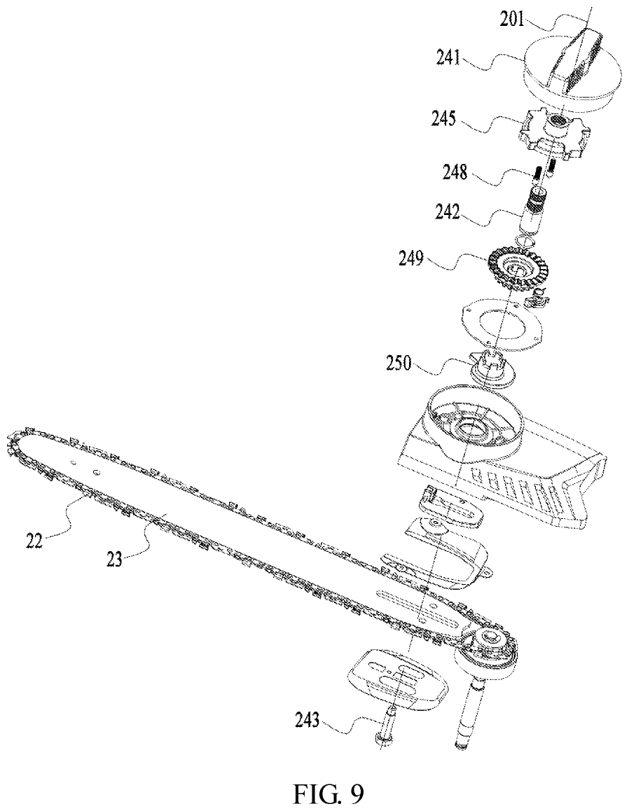

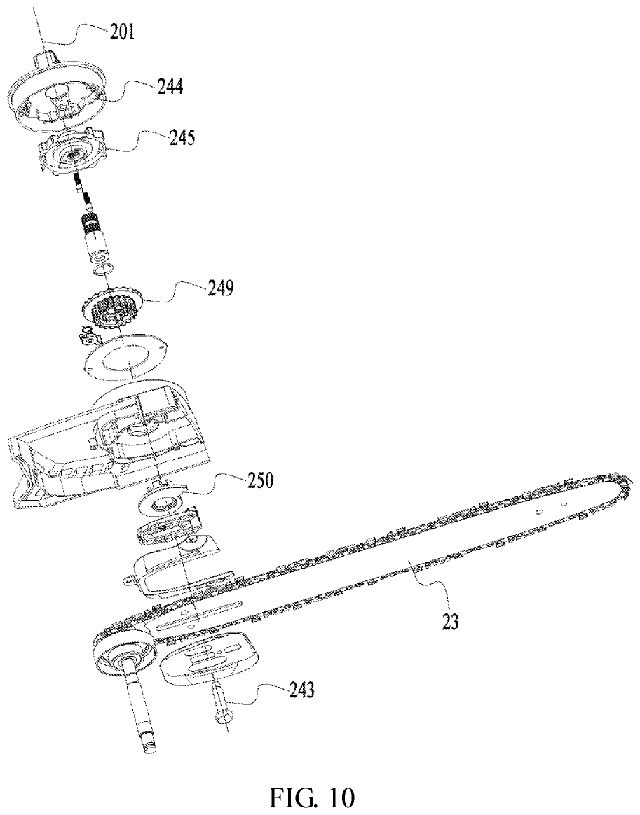

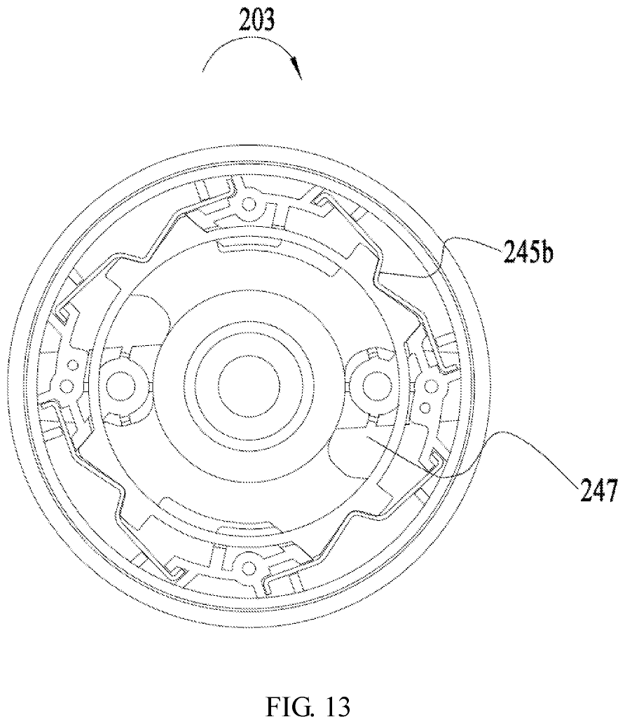

As shown in FIG. 9 to FIG. 13, a chain saw 200 according to a second example may have the same structure of the main body, the power output unit, and the guide plate 23 as shown in the first example, but the structure of an operating member 241 and a first locking member 242 of the locking device 24 in this example are different. The portions of the first example that are compatible with the present example can be applied to the present example. Only the differences between the present example and the first example will be described below.

In this example, the operating member 241 and the first locking member 242 are no longer fixedly connected or integrally formed. The first locking member 242 is fixedly connected with a fourth clutch 245 and forms a fastening body. The operating member 241 is fixedly connected to the third clutch 244, and the fastening body cooperates with the third clutch 244 to realize the clutching of the operating member 241 and the first locking member 242. The third clutch 244 is a resilient elastic piece, detachably mounted in a preset limit slot in the operating member 241 and having a first stop surface 244a. The fourth clutch 245 is formed with a clutching portion around the first axis 201. The clutching portion is formed with a second stop surface 245a and a third stop surface 245b, the second stop surface 245a has a third slope, the third stop surface 245b has a fourth slope, and the absolute value of the fourth slope is greater than that of the third slope. The fourth clutch 245 forms a stop slot along the direction of the first axis 201, the stop slot cooperates with the protruding screw hole of the operating member 241 such that the first position and the second position exist between the fourth clutch 245 and the operating member 241.

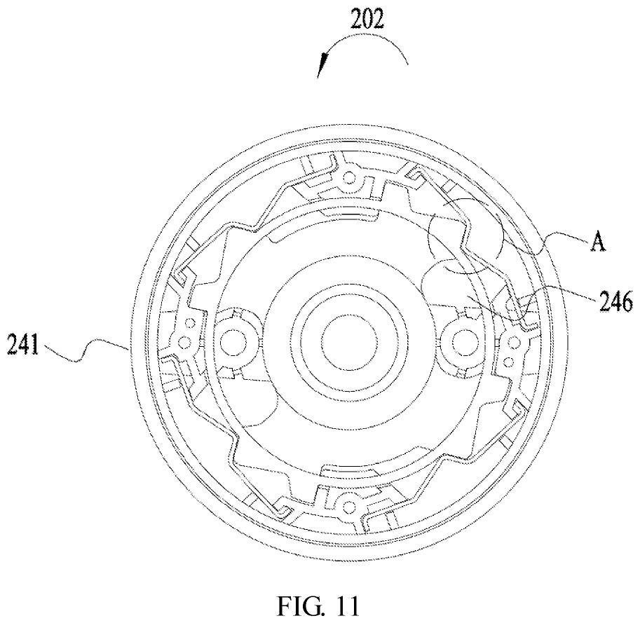

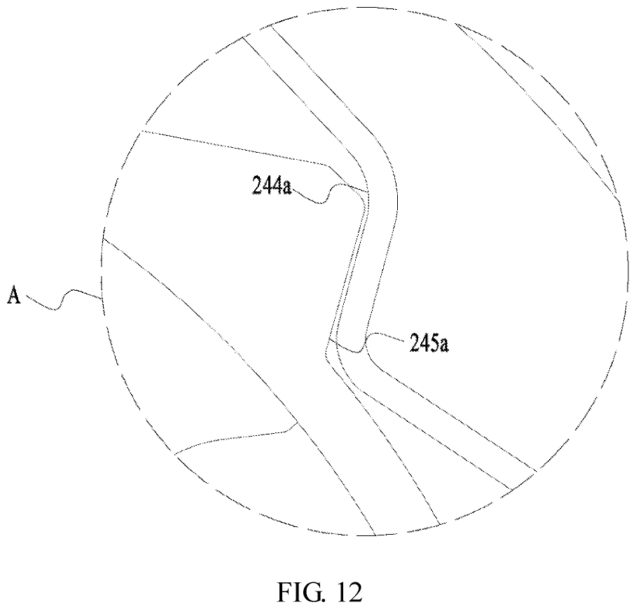

When the user twists the operating member 241 to rotate in a first direction 202, as shown in FIG. 11 and FIG. 12, the operating member 241 and the fourth clutch 245 are in the first position, the first stop surface 244a cooperates with the second stop surface 245a, the third clutch 244 is in a third state relative to the fourth clutch 245, the operating member 241 drives the fastening body to rotate synchronously, thereby driving the second clutch 249 and the driving member 250 to rotate, and the chain 22 is tensioned. When the chain 22 is tensioned to the preset tension, the operating member 241 is continuously twisted, a pin 248a of a first clutch 248 passes over the first sloped surface, the first clutch 248 and the third clutch 244 are in relative motion, and the third clutch 244 is in a fourth state relative to the fourth clutch 245. The second clutch 249 is no longer rotated synchronously with the operating member 241 in the first direction 202. Further, since a guide plate 23 is clamped between the first locking member 242 and a second locking member 243, therefore, during the above-mentioned operation, the first locking member 242 is gradually tightened to the second locking member 243, and the guide plate 23 is gradually clamped to the main body. When the guide plate 23 is clamped, the operating member 241 is continuously twisted, and the first stop surface 244a of the third clutch 244 will pass over the second stop surface 245a of the clutching portion. Then the user can hear a “click” to be reminded that the guide plate 23 has been tightened. At this moment the third clutch 244 does not limit the rotation of the forth clutch 245, and the fourth clutch 245 is rotated to the second position. At this moment, the operating member 241 is continuously twisted, since the protruding screw hole of the operating member 241 is limited in the stop groove, the operating member 241 can drive the fastening body to continue to rotate, thereby continuing to tighten the guide plate 23.

When the third clutch 244 and the fourth clutch 245 are kept in the first position, the first stop surface 244a cooperates with the second stop surface 245a, the third clutch 244 is in a third state capable of limiting the rotation of the fourth clutch 245, at this moment, the operating member 241 is twisted to rotate in the second direction 203, and then the operating member 241 drives the fastening body to rotate in the second direction 203 to loosen the guide plate 23. When the third clutch 244 and the fourth clutch 245 are kept in the second position, the third clutch 244 does not limit the rotation of the forth clutch 245, at this moment, the operating member 241 is twisted to rotate in the second direction 203, and then the operating member 241 drives the fastening body to rotate in the second direction 203 to loosen the guide plate 23 by cooperation between the stop groove and the protruding screw hole.

It can be understood that the convex portion of the operating member 241 can be adjusted outside the range where the fourth clutch 245 rotates, at this moment, the operating member 241 and the fourth clutch 245 have no relative position. When the user operates the operating member 241 to rotate in the first direction 202, the clutch torque reaches the maximum value, and the stop surface of the third clutch 244 passes over the second stop surface 245a of the fourth clutch 245, the third clutch 244 is in the fourth state relative to the fourth clutch 245, and can continue to rotate to the next stop surface of the fourth clutch 245 to realize the clutching again, so that the guide plate 23 can be tightened through continuous clutching; conversely, when the user operates the operating member 241 to rotate in the second direction 203, since the second stop surface 245a is formed with a third slope, the third stop surface 245b is formed with a fourth slope, and the absolute value of the fourth slope is greater than that of the third one, therefore, the maximum clutch torque generated in the second direction is greater than that of the first direction, the third clutch 244 is in the third state relative to the fourth clutch 245, and the third clutch 244 transmits the rotation to the fourth clutch 245 and the guide plate 23 is loosened.

The above illustrates and describes basic principles, main features and advantages of the subject disclosure. It is to be understood by those skilled in the art that the above examples do not limit the subject disclosure in any form, and all solutions obtained by means of equivalent substitution or equivalent transformation fall within the protection scope of the claims which follow.

What is claimed is:

1. A chain saw, comprising:
a chain;
a guide plate for supporting and guiding the chain;
a main body comprising a power output unit configured for driving the chain to cut a workpiece; and
a locking device configured for fixing the guide plate and tensioning the chain;
wherein the locking device comprises:
a device housing;
an operating member configured to be operated by a user to rotate about a first axis;
a first locking member configured for locking or releasing the guide plate; and
a first clutch assembly comprising a first clutch and a second clutch;
wherein the first clutch assembly has a first state and a second state, the first clutch is operative to transmit a rotation of the operating member to the second clutch when the first clutch assembly is in the first state, the first clutch is operative to stop transmitting the rotation to the second clutch, and the first clutch assembly is operative to produce a relative displacement relative to the second clutch when the first clutch assembly is in the second state.

2. The chain saw according to claim 1, wherein the relative displacement of the first clutch relative to the second clutch comprises a displacement component along the first axis.

3. The chain saw according to claim 1, wherein the relative displacement of the first clutch relative to the second clutch comprises a displacement component along a radial direction perpendicular to the first axis.

4. The chain saw according to claim 1, wherein the first clutch includes a first elastic member and a pin which is fixedly or detachably connected to the first elastic member.

5. The chain saw according to claim 4, wherein the second clutch is formed with a clutching portion and the first clutch is biased to a position that is always in constant contact with the clutching portion.

6. The chain saw according to claim 5, wherein the clutching portion includes a first sloped surface and a second sloped surface, the first sloped surface defines a first slope, and the second sloped surface defines a second slope.

7. The chain saw according to claim 1, wherein the locking device further comprises a second locking member and wherein the first locking member is fixedly connected to or integrally formed with the operating member, the second locking member is connected to the main body and passes through the guide plate, and the first clutch is fixedly or detachably connected to the operating member.

8. The chain saw according to claim 8, wherein the second locking member is moveable relative the first locking member to clamp the guide plate.

9. The chain saw according to claim 1, wherein the locking device further comprises a pawl detachably connected to the device housing, the second clutch is formed with a ratchet, and the pawl is unidirectionally engaged with the ratchet so that the second clutch is operative to rotate in only one direction.

10. The chain saw according to claim 1, wherein the chain saw further comprises a push plate fixedly connected to the guide plate and formed with a convex portion and a driving member formed with a spiral block which is operative to move simultaneously with the second clutch to push the convex portion to tension the chain.
